(19) United States
(12) Patent Application Publication
(10) Pub. No.: US 2017/0096224 A1
(43) Pub. Date: Apr. 6, 2017

(54) VEHICLE SEAT SLEEPING DEVICE

(71) Applicant: ITAMAR MAROM, Bet Dagan (IL)

(72) Inventor: ITAMAR MAROM, Bet Dagan (IL)

(21) Appl. No.: 15/286,011

(22) Filed: Oct. 5, 2016

(30) Foreign Application Priority Data
Oct. 6, 2015 (IL) 241884

(51) Int. Cl. B64D 11/06; B64D 11/00

(52) U.S. Cl. CPC B64D 11/0642; B64D 11/00151

(57) ABSTRACT

An airplane seat sleeping device for providing a forwardly inclining head support that is attached or attachable to an adjacently proceeding vehicle seat, which has a seatback. The device includes a seatback attachment mechanism configured to be attachable to the seatback of the adjacently proceeding vehicle seat; a pillow support member; an intermediate member connecting the seatback attachment mechanism to the pillow support member; and a pillow support/receiving holding mechanism.

### CROSS REFERENCE TO RELATED APPLICATIONS

This application claims priority from Israel patent application 241884, entitled “An airplane chair sleeping device”, filed 6 Oct. 2015, the contents of which are hereby incorporated by reference.

### FIELD OF THE INVENTION

The present invention relates to vehicle accessories, more specifically to a device to help a passenger sleep, in particular a pillow support device.

### BACKGROUND OF THE INVENTION

People often enjoy sleeping when travelling by train, bus, airplane, automobile and the like. Although many travelers use neck-pillows and incline backwards when trying to sleep, leaning forward is also a desirable position for such sleeping.

For sleeping in an upright or forwardly bent position, travel pillows, cushions and devices have been disclosed in U.S. Pat. No. 8,985,693 (The Boeing Company, Mar. 24, 2015); U.S. Pat. No. 6,647,573 (Corbin, Nov. 18, 2003); and US 2015/107,025 (Dauphin, Apr. 23, 2015).

### SUMMARY OF THE INVENTION

The present vehicle seat sleeping device relates to a travel pillow assembly for a passenger. The device is mountable on the seatback of the seat in front of the passenger and may include a pillow so the passenger can sleep in a forward leaning position. The device is conveniently foldable for easy storage and carrying when not in use. Alternatively, the device can be designed as an integral accessory of vehicle seats.

In some embodiments, the present invention provides a vehicle seat sleep device allowing a forwardly inclining head support that is attached or attachable to an adjacently proceeding vehicle seat, which has a seatback. The device includes: a seatback attachment mechanism configured to be attachable to the seatback of the adjacently proceeding vehicle seat; a pillow support member; an intermediate member connecting the seatback attachment mechanism to the pillow support member; and a pillow support/receiving holding mechanism.

In some embodiments, the pillow support or pillow receiving member is constituted by a pair of pivotably connected members. In some embodiments, the device includes a video screen viewing opening. In some embodiments, the seatback attachment mechanism is configured so that the device is removably attachable to the seatback of the adjacently proceeding vehicle seat. In some embodiments, the seatback attachment mechanism includes one or more attachment plates each of the plates having a slot and a fastener. In some embodiments, the seatback attachment mechanism includes a seatback headrest cover and straps. In some embodiments, the straps include first upper seatback connection straps; second upper seatback connection straps; and lower seatback connection straps.

In some embodiments, the pillow support member is constituted by a first pillow support member and a second pillow support member pivotably connected therebetween. In some embodiments, the first pillow support member and the second pillow support member are configured to be foldable to a position parallel to the intermediate member. In some embodiments, the intermediate member includes a pillow support holder for holding the pillow support member in a position parallel to the intermediate member. In some embodiments, the pillow support holder includes a latch corresponding to a cutout at the underside of the pillow support member for maintaining the pillow support member in an upright compact arrangement. In some embodiments, the pillow support/receiving holding mechanism includes an angle adjustment mechanism configured to allow the angle of the pillow support member to be adjusted. In some embodiments, the pillow support member includes a pocket configured to hold a pillow.

Advantages of some embodiments include: (a) the device provides a particularly comfortable sleeping position for the user/traveler, in particular in a forwardly inclining upper-body position; (b) the device can be designed as an integral or a portable device (i.e. compact and light); (c) the device does not block the video screen in the back of the adjacent forward seat; (d) the device can be adjusted to provide various incline angles to suit the user/traveler; (e) the device can include a pillow (e.g. inflatable) conveniently wrapped therein, or accommodate another pillow, such as those commonly available on airplane flights; (f) the device is conveniently adjustable to be placed in a folded position whereby other passengers can easily pass by; and (g) the device has a simple design for easy use and manufacturability.

### BRIEF DESCRIPTION OF THE DRAWINGS

The invention may be more clearly understood upon reading of the following detailed description of non-limiting exemplary embodiments thereof, with reference to the following drawings, in which:

FIG. 1A is a perspective view of a vehicle seat sleeping device in accordance with embodiments of the present invention;

FIG. 1B is a detailed view of a portion of a support mechanism of the device of FIG. 1A;

FIG. 2A is a perspective view of the vehicle seat sleeping device in accordance with other embodiments of the present invention;

FIG. 2B is a perspective view of an embodiment of a pillow support angle adjustment member of the device.

FIG. 2C is a perspective view of a connector mechanism of the device:

FIG. 3 is a perspective view of the vehicle seat sleeping device in accordance with yet other embodiments of the present invention; and

FIGS. 4 and 5 are perspective views of the vehicle seat sleeping device in accordance with still other embodiments of the present invention particularly suited convenient portability and storage, in respective open and in-use positions.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

Illustrative embodiments of the invention are described below. In the interest of clarity, not all features/components of an actual implementation are necessarily described.

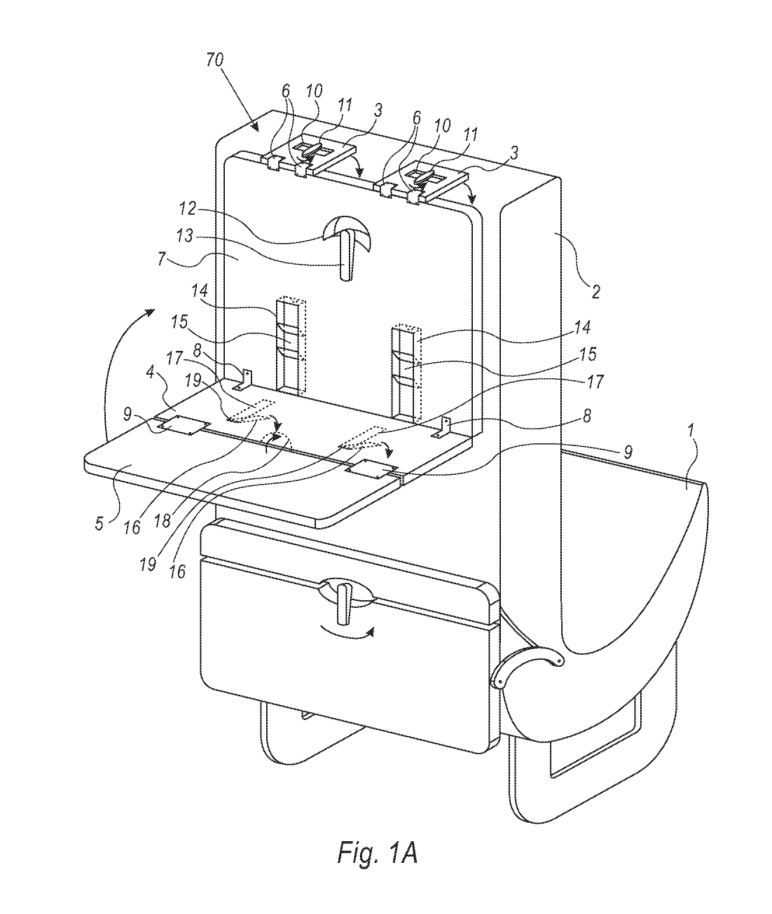

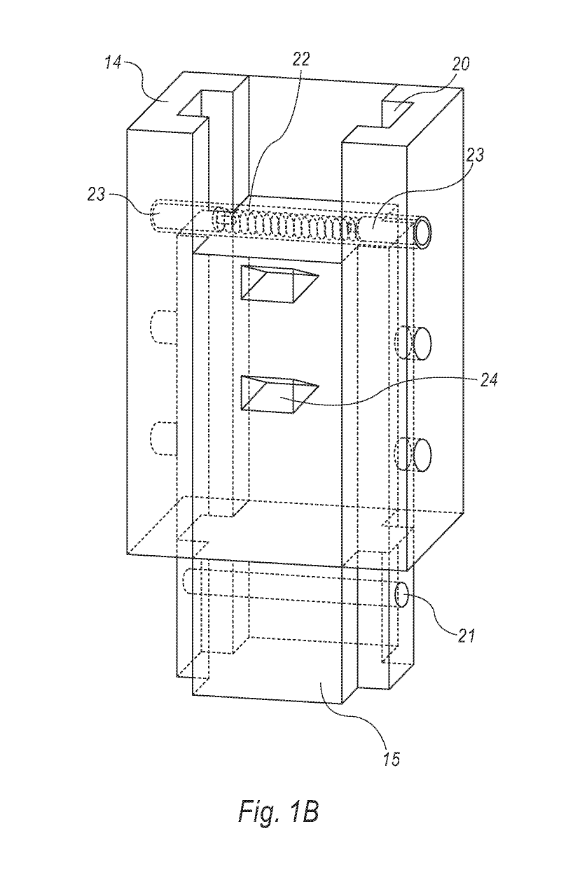

FIG. 1 shows an embodiment of a vehicle seat sleeping device in accordance with embodiments of the present invention in an open, ready for use position. The sleeping device includes a seatback attachment mechanism 70 for attaching/mounting the device to the top of the seatback 2 of the seat 1 in front of the user; a pair of pillow support members, namely a first pillow support member 4 and a second pillow support member 5; and an intermediate member 7 connecting between the seatback attachment mechanism 70 and the support members 4 and 5 (via respective connectors or brackets 6 and 8).

Seatback attachment mechanism 70 includes a pair of attachment plates 3 each having a slot 10 and a fastener 11 for connecting the attachment mechanism to the seatback 2.

First pillow support member 4 and second pillow support member 5 are pivotably attached to each other via a hinge or pair of hinges 9, whereby second pillow support member 5 can fold onto first pillow support member 4. For maintaining the device in a compact arrangement, the pillow support members 4 and 5 can be further folded up to a position parallel to intermediate member 7. For such reason, intermediate member 7 has a holder 12 with a latch or holding piece corresponding to a cutout 18 at the underside of first pillow support member 4 for maintaining pillow support members 4 and 5 in an upright compact arrangement whereby they are out of the way of the user or another passenger(s) who may wish to pass by.

On the underside of first pillow support member 4 are a pair of recesses for receiving respective support legs 16 pivotably connected to the underside of first pillow support member 4 by respective hinges 19.

With reference also to FIG. 1B, intermediate member 7 includes a pair of support leg bases 14 configured to receive the free ends of respective support legs 16. In some embodiments, support leg bases 14 include an adjustable feature that is constituted by an adjustable piece 15 slidable within elongated notches 20 and having one or more support leg receiving recesses 24 therein; as well as including an adjustment pin 23 with a spring 22 to allow the pin to be compressed and moved between a plurality of aperture pairs 21 to allow height adjustment and thus control the angle of support members 4 and 5.

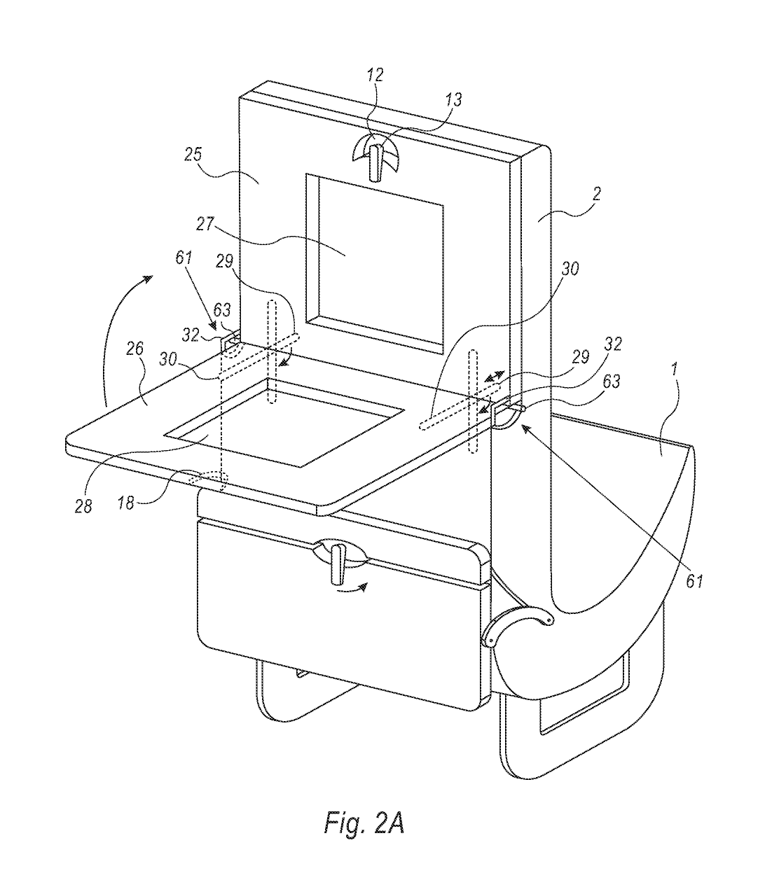

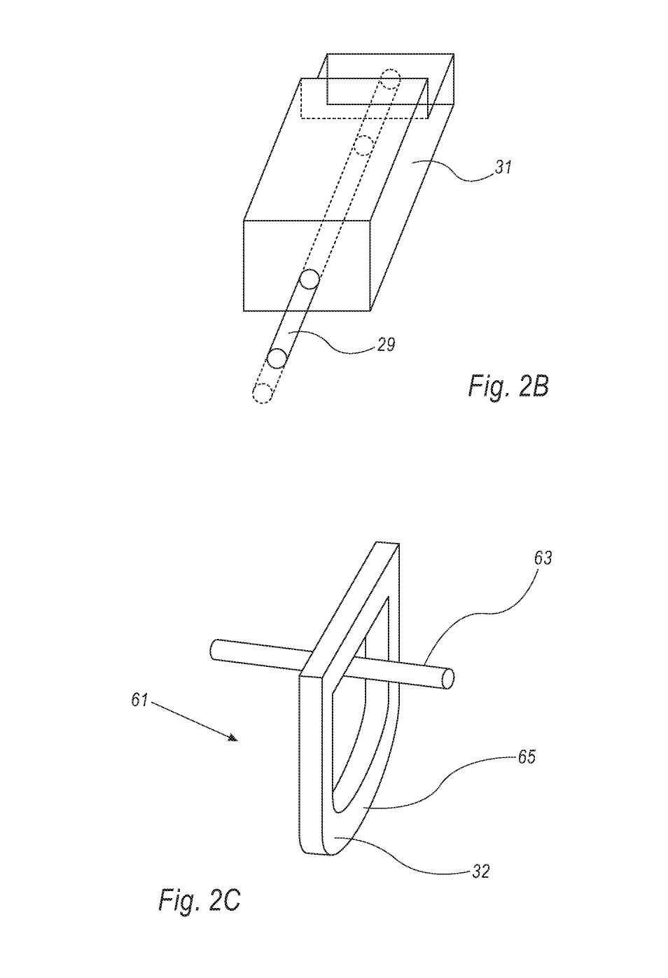

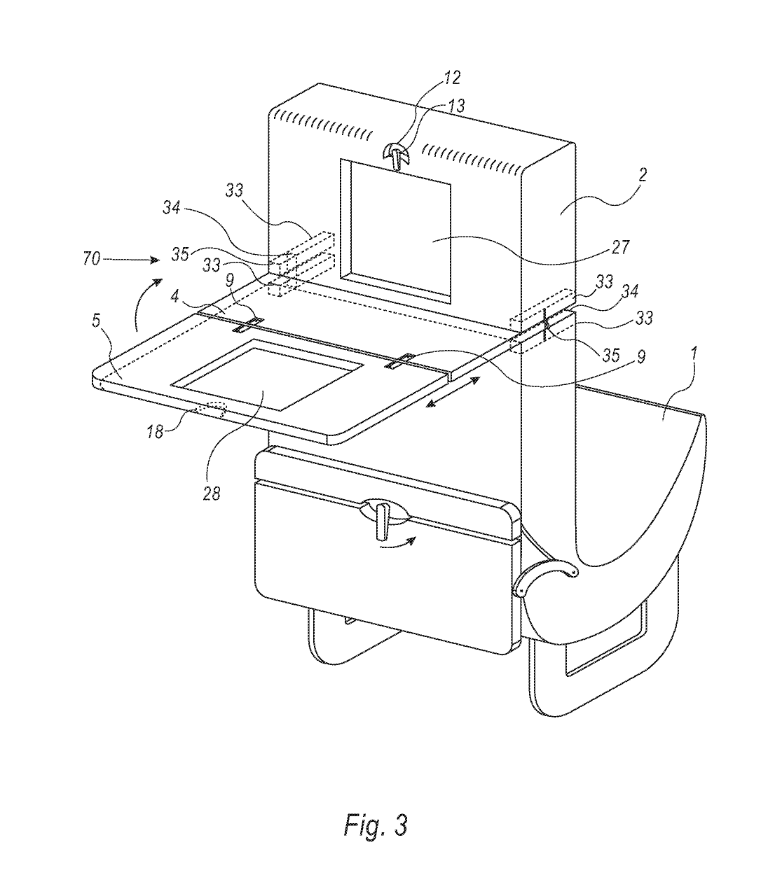

FIGS. 2A-2C show other embodiments of the vehicle seat sleeping device (no seatback attachment mechanism is shown). Intermediate member 7 has an opening 27 intended to correspond to a video screen (not shown), such as may be found on the backside of seatback 2 for showing movies and the like in an airplane. Pillow support 26 (essentially an equivalent to support members 4 and 5 in FIG. 1A) also has an opening 28 corresponding to opening 28. As such, the user may conveniently view the video screen when support member is in a horizontal position ready for use, or in folded up position.

FIG. 2A also illustrates a variation of support legs 16 exemplified by support rods 29, which fit into respective support rod lumens 30.

With reference to FIG. 2B, in some embodiments, the portion of lumen 30 that is disposed in intermediate member 7 is constituted by a two-tiered box-like support rod receiving cavity 31 whereby support rod 29 can be inserted all the way back to provide a first angle of pillow support 26 (e.g. 90 degrees), or pulled outward a bit so that the rod can angle downward and thus provide another slope to pillow support 26.

FIG. 2C shows an exemplary connector mechanism 61 of the device configured to pivotally connect between intermediate member 7 and pillow support member 4 whereby the device can be put in an opened position for use and also placed in a non-use position with the pillow support folded up to the intermediate member. Connector mechanism 61 has a connector pivot rod 63 and a frame-like bracket 32 with an arched portion 65 allowing for the aforementioned pivoting, which in similar embodiments can be pivoting like that of a door.

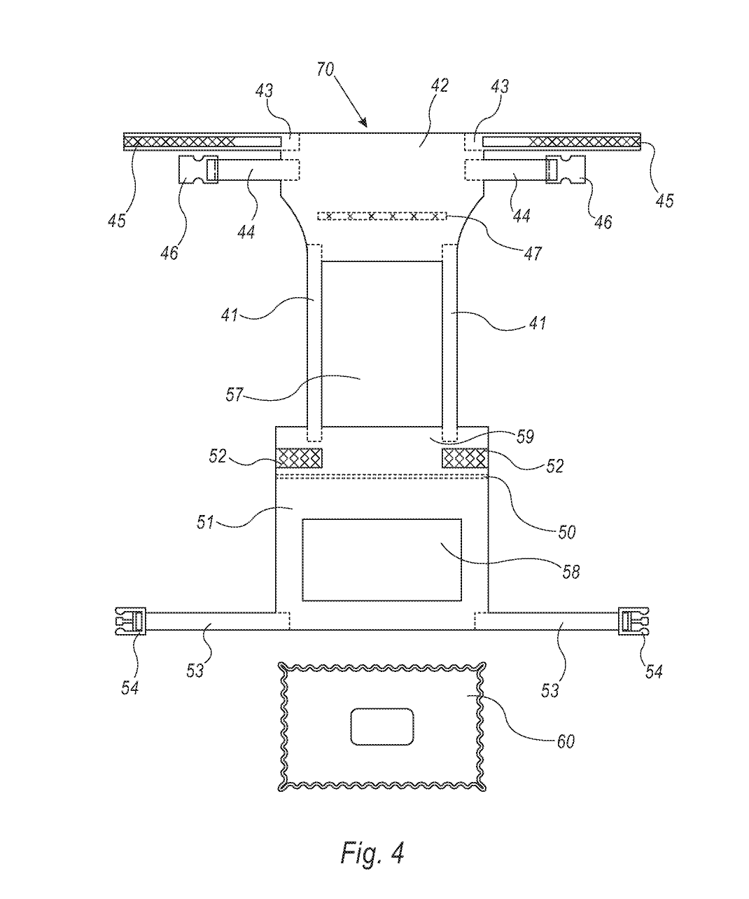

FIG. 3 shows another embodiment that is somewhat like a combination of the embodiments of FIGS. 1A-1B and FIGS. 2A-2C. Here, pillow support member 4 is supported by a cantilever arrangement in seatback 2 having reinforcements 33 and an elongated slot 34 into which the far edge of the pillow support member can be inserted.

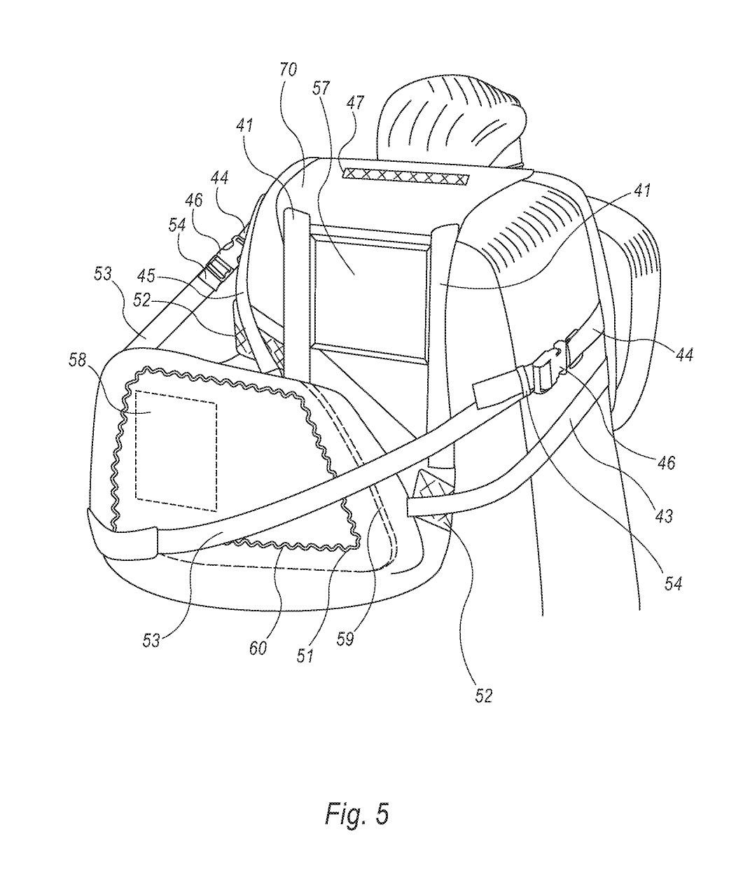

FIGS. 4 and 5 show another embodiment that is more conducive to portability, made of a suitable fabric. The seatback attachment mechanism 70 here includes a headrest cover 42; and connection straps, exemplified by first upper seatback connection straps 43; second upper seatback connection straps 44; and lower seatback connection straps 53. The straps 43, 44 and 53 include fasteners, exemplified by female fasteners 46 at the ends of straps 44, which correspond to male fasteners 54 at the ends of straps 53; and hook and loop fastener hooks 45 of straps 43, which correspond to hook and loop fastener loops 52.

A pillow support piece 51 may include a pocket 58 for a pillow 60 to fit therein, whereby the pillow can be part of the device (kit) for ease of use and to ease storage and portability. Pillow 60 can be an inflatable pillow. Alternatively, if the user is flying, the user can use a pillow supplied by the airlines; or, any other appropriately sized pillow. The device can also include a zipper 50 at pillow support piece 51 useful for closing the device into a convenient compact storable state. Suspension straps 41 connect between headrest cover 42 and pillow support piece 51 (for example a pillow support strip 59), and along with the cover and support piece, define an opening 57 through which an airplane video screen (or the like) can be viewed. The device may also include a hygienic cloth holder strip 47, which could be constituted by a hook-loop fastener.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A vehicle seat sleeping device for providing a forwardly inclining head support that is attached or attachable to an adjacently proceeding vehicle seat, which has a seatback, the device comprising:
a seatback attachment mechanism configured to be attachable to said seatback of said adjacently proceeding vehicle seat;
a pillow support member;
an intermediate member connecting said seatback attachment mechanism to said pillow support member; and
a pillow support/receiving holding mechanism.

2. The device of claim 1, wherein the pillow support or pillow receiving member is constituted by a pair of pivotably connected members.

3. The device of claim 1, further comprising a video screen viewing opening.

4. The device of claim 1, wherein the seatback attachment mechanism is configured so that the device is removably attachable to said seatback of said adjacently proceeding vehicle seat.

5. The device of claim 1, wherein the seatback attachment mechanism comprises one or more attachment plates each of the plates having a slot and a fastener.

6. The device of claim 1, wherein the seatback attachment mechanism comprises a seatback headrest cover and straps.

7. The device of claim 6, wherein the straps comprise first upper seatback connection straps; second upper seatback connection straps; and lower seatback connection straps.

8. The device of claim 1, wherein the pillow support member is constituted by a first pillow support member and a second pillow support member pivotably connected therebetween.

9. The device of claim 1, wherein the first pillow support member and the second pillow support member are configured to be foldable to a position parallel to the intermediate member.

10. The device of claim 9, wherein the intermediate member comprises a pillow support holder for holding the pillow support member in a position parallel to the intermediate member.

11. The device of claim 10, wherein the pillow support holder comprises a latch corresponding to a cutout at the underside of the pillow support member for maintaining the pillow support member in an upright compact arrangement.

12. The device of claim 1, wherein the pillow support/receiving holding mechanism comprises an angle adjustment mechanism configured to allow the angle of the pillow support member to be adjusted.

13. The device of claim 1, wherein the pillow support member includes a pocket configured to hold a pillow.
